(19) United States
(12) Patent Application Publication
(10) Pub. No.: US 2026/0235396 A1
(43) Pub. Date: Aug. 13, 2026

(54) MEASUREMENT DEVICES AND MEASUREMENT METHODS FOR ZERO-POINT POSITIONING OF MACHINE TOOL ROTARY AXES

(71) Applicant: CHENGDU AIRCRAFT INDUSTRIAL (GROUP) CO., LTD., Chengdu (CN)

(72) Inventors: Chongkai PAN, Chengdu (CN); Dawei LIU, Chengdu (CN); Debiao ZENG, Chengdu (CN); Liangqiang DAI, Chengdu (CN); Guangliang DONG, Chengdu (CN); Xuezhen CHEN, Chengdu (CN); Weiwei ZHANG, Chengdu (CN); Ruihua GUO, Chengdu (CN); Jian GAN, Chengdu (CN); Changyong ZHAO, Chengdu (CN); Chao ZHOU, Chengdu (CN); Bing LIU, Chengdu (CN); Xiang ZHOU, Chengdu (CN); Fengfeng GAO, Chengdu (CN); Qiang XU, Chengdu (CN); Qiangrong GAO, Chengdu (CN); Sang CHEN, Chengdu (CN); Houchuan ZHOU, Chengdu (CN)

(73) Assignee: CHENGDU AIRCRAFT INDUSTRIAL (GROUP) CO., LTD., Chengdu (CN)

(21) Appl. No.: 19/632,443

(22) Filed: Mar. 30, 2026

Related U.S. Application Data
(63) Continuation of application No. PCT/CN2024/100362, filed on Jun. 20, 2024.

(30) Foreign Application Priority Data
Oct. 23, 2023 (CN) 202311374908.4

(51) Int. Cl. G01B 11/00; B23Q 17/22; G05B 19/402

(52) U.S. Cl. CPC G01B 11/005; B23Q 17/22; G05B 19/402; G05B 2219/33099

(57) ABSTRACT

Disclosed are a measurement device and a measurement method for zero-point positioning of a machine tool rotary axis. The measurement device includes a mounting frame which is provided with a non-contact detection module. The measurement device includes a communication module and a data processing module. An input terminal of the communication module is connected to the non-contact detection module. An output terminal of the communication module is connected to the data processing module. Compared with the prior art, the present disclosure replaces a mandrel in the prior art with the non-contact detection module. By adjusting an effective range of the non-contact detection module, all parameters are collected at the first time when calibrating a reference detection surface. Results are automatically calculated and output. The measurement device helps those skilled in the art to quickly determine whether zero-point positioning of the machine tool rotary axis meets requirements, thereby improving detection efficiency.

### CROSS-REFERENCE TO RELATED APPLICATIONS

This application is a Continuation of the International Application No. PCT/CN2024/100362, filed on Jun. 20, 2024, which claims priority to the Chineses Patent Application No. 202311374908.4, filed on Oct. 23, 2023, the contents of each of which are hereby incorporated by reference.

### TECHNICAL FIELD

The present disclosure generally relates to the field of detection equipment, in particular to a measurement device and a measurement method for zero-point positioning of a machine tool rotary axis.

### BACKGROUND

Computer numerical control (CNC) machine tools are widely used in the field of mechanical processing. Zero-point positioning accuracy of a machine tool rotary axis is an important basis for guaranteeing the quality of part processing. A main way for machine tool accuracy detection is to conduct manual detection by using detection tools such as a mandrel and a dial indicator. However, the detection way described above is time-consuming and is greatly affected by skill proficiency of operators. Particularly in automated production lines with high-volume part processing, manual detection significantly disrupts the rhythm of production. Existing industrial-scale production imposes higher requirements on the efficiency of fixed-point positioning accuracy detection for machine tools.

Therefore, it is desirable to provide a measurement device and a measurement method for zero-point positioning of a machine tool rotary axis to solve the problem of low detection efficiency.

### SUMMARY

One or more embodiments of the present disclosure provide a measurement device for zero-point positioning of a machine tool rotary axis. The measurement device includes a mounting frame; a non-contact detection module, wherein the non-contact detection module is configured to calibrate a reference detection surface, and the non-contact detection module is connected to the mounting frame; a communication module, wherein the communication module is communicatively connected to the non-contact detection module; and a data processing module, wherein the data processing module is communicatively connected to the communication module.

One or more embodiments of the present disclosure provide a measurement method for zero-point positioning of a machine tool rotary axis. The measurement method includes: placing a standard detection block on a machine tool, and selecting a reference detection surface on the standard detection block; setting a detection trajectory based on a mounting position of the standard detection block, and acquiring a distance parameter between a non-contact detection module and the reference detection surface; setting an effective range of the non-contact detection module; mounting a measurement device on a standard spindle, moving the standard spindle along the detection trajectory, and acquiring standard coordinates; mounting the measurement device on a spindle to be tested, moving the spindle to be tested along the detection trajectory, and acquiring detection coordinates; and calculating a positioning accuracy deviation based on the distance parameter, the effective range, the standard coordinates, and the detection coordinates.

### BRIEF DESCRIPTION OF THE DRAWINGS

FIG. 1 is a schematic structural diagram of a measurement device for zero-point positioning of a machine tool rotary axis according to some embodiments of the present disclosure;

FIG. 2 is a schematic structural diagram of a mounting frame according to some embodiments of the present disclosure;

FIG. 3 is a flowchart of a measurement method for zero-point positioning of a machine tool rotary axis according to some embodiments of the present disclosure;

FIG. 4 is a schematic diagram of a calculation principle of a positive deviation according to some embodiments of the present disclosure;

FIG. 5 is a schematic diagram of a calculation principle of a negative deviation according to some embodiments of the present disclosure.

Reference signs in the figures: 1: mounting frame; 2: non-contact detection module; 3: communication module; 4: data processing module; 5: end cap; 6: light-transmitting hole.

### DETAILED DESCRIPTION

The technical solutions in the embodiments of the present disclosure are described clearly and completely below with reference to the accompanying drawings in the embodiments of the present disclosure. Obviously, the described embodiments are only some embodiments of the present disclosure, not all embodiments. Based on the embodiments of the present disclosure, all other embodiments acquired by a person of ordinary skill in the art without creative efforts fall within the scope of protection of the present disclosure.

It should be noted that directional indications (e.g., up, down, left, right, front, back, etc.) in the embodiments of the present disclosure are only used to explain relative positional relationships and movement conditions among components in a specific posture (as shown in the accompanying drawings). If the specific posture changes, the directional indication changes accordingly.

In the present disclosure, unless otherwise explicitly specified and limited, terms such as “connect” and “fix” should be understood broadly. For example, “fix” may be a fixed connection, a detachable connection, or an integral connection; or may be a mechanical connection, an electrical connection, a direct connection, an indirect connection through an intermediate medium, an internal connection between two elements, or an interaction relationship between two elements, unless otherwise explicitly limited. A person of ordinary skill in the art may understand specific meanings of the above terms in the present disclosure according to specific situations.

In addition, if descriptions such as “first” and “second” are involved in the embodiments of the present disclosure, the descriptions such as “first” and “second” are for descriptive purposes only, and cannot be understood as indicating or implying relative importance or implicitly indicating a quantity of the indicated technical features. Thus, features defined with “first” and “second” may explicitly or implicitly include at least one such feature. In addition, the meaning of “and/or” appearing in the full text includes three parallel schemes. Taking “A and/or B” as an example, the schemes include a scheme A, a scheme B, or a scheme satisfying both A and B. In addition, technical solutions among various embodiments may be combined with each other, but the combination must be based on what can be achieved by a person of ordinary skill in the art. When a combination of technical solutions is contradictory or cannot be achieved, the combination of technical solutions should be considered non-existent and not within the scope of protection claimed by the present disclosure.

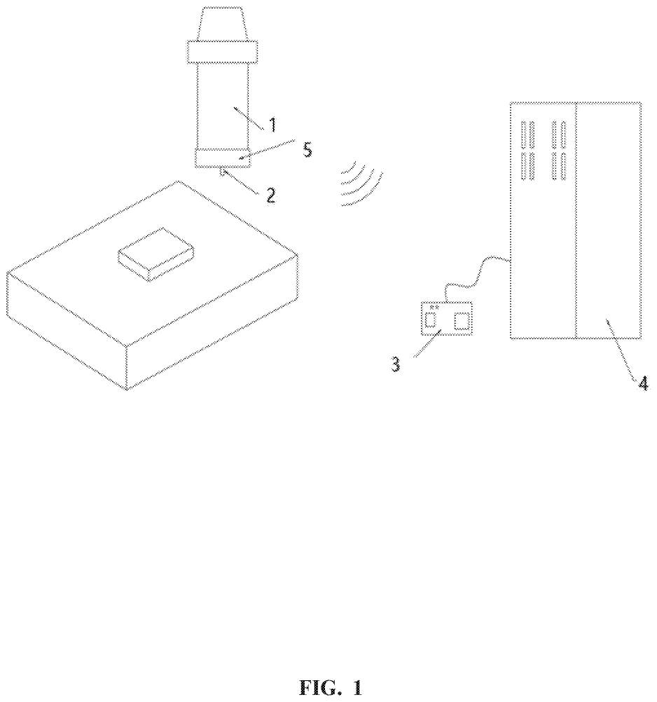

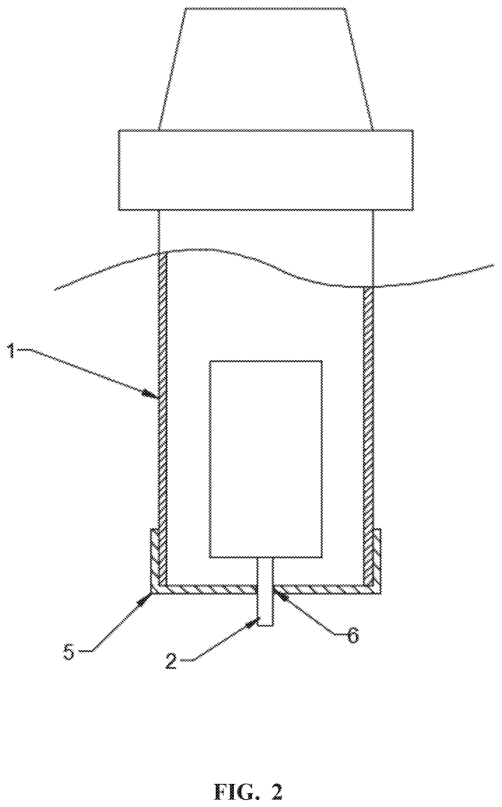

FIG. 1 is a schematic structural diagram of a measurement device for zero-point positioning of a machine tool rotary axis according to some embodiments of the present disclosure. FIG. 2 is a schematic structural diagram of a mounting frame according to some embodiments of the present disclosure.

In some embodiments, as shown in FIGS. 1-2, the measurement device for zero-point positioning of the machine tool rotary axis may include a mounting frame 1 and a non-contact detection module 2. The non-contact detection module 2 may be configured to calibrate a reference detection surface, and the non-contact detection module 2 may be connected to the mounting frame 1. The measurement device may include a communication module 3. The communication module 3 may be communicatively connected to the non-contact detection module 2. The measurement device may further include a data processing module 4. The data processing module 4 may be communicatively connected to the communication module 3.

The mounting frame 1 is a mechanical support and connection carrier of the measurement device. In some embodiments, the mounting frame 1 includes a tool holder and a housing. A top of the housing may be connected to the tool holder. The tool holder may be configured to connect to a tool claw of a spindle of a machine tool to be tested. The housing is a component configured to carry the machine tool to be tested.

The non-contact detection module 2 is a module configured to calibrate the reference detection surface in a non-contact manner. The reference detection surface may be a preset reference plane on the non-contact detection module. The reference detection surface may be determined based on manual experience. The non-contact detection module 2 may be connected to the mounting frame 1. More descriptions regarding the non-contact detection module 2 may be found below and the related descriptions thereof.

In some embodiments, the non-contact detection module 2 may be provided with a wireless communication signal transmitter configured to implement inter-module communication.

The communication module 3 may be configured to implement communication between modules or with an external machine tool. The communication module 3 may be a wireless communication module such as a Bluetooth communication module. An input terminal of the communication module 3 may be communicatively connected to the wireless communication signal transmitter of the non-contact detection module 2. An output terminal of the communication module 3 may be connected to a signal acquisition port of the external machine tool (also referred to as a machine tool to be tested or a machine tool) via a wire, such as an input point of a programmable logic controller (PLC) digital input module of a computer numerical control (CNC) machine tool. More descriptions regarding the communication module 3 may be found below and the related descriptions thereof.

The data processing module 4 is a module configured to process measurement data of the non-contact detection module 2. The data processing module 4 may be a central processing unit (CPU), a graphics processing unit (GPU), an application-specific integrated circuit (ASIC), a field-programmable gate array (FPGA), or the like, or any combination thereof.

The data processing module 4 may be communicatively connected to the communication module 3.

In some embodiments, the data processing module 4 may communicate with the communication module 3 to send a positioning accuracy deviation to the external machine tool.

In some embodiments of the present disclosure, by calibrating the reference detection surface through the non-contact detection module 2, the measurement device can complete collection of all parameters while calibrating the reference detection surface and automatically calculate and output a result. The entire detection process requires no manual intervention, and has a high degree of automation, thereby greatly improving measurement efficiency.

In some embodiments, the non-contact detection module 2 includes a laser emitter. A bottom of the mounting frame 1 may be provided with an end cap 5. The end cap 5 may be provided with a light-transmitting hole 6 adapted to a measuring end of the laser emitter.

The laser emitter can emit a laser beam for detecting the reference detection surface. The laser emitter may be a device equipped with a wireless communication module. The laser emitter may be disposed in a housing. A laser measuring end of the laser emitter may be inserted into the light-transmitting hole 6. The laser measuring end refers to an end of the laser emitter from which the laser beam is emitted.

In some embodiments, the non-contact detection module 2 further includes the wireless communication signal transmitter. The wireless communication signal transmitter refers to a component configured to transmit data generated during detection of the reference detection surface to other modules (e.g., the communication module 3). The wireless communication signal transmitter may use a Bluetooth communication module or another communication module for communication.

The end cap 5 is a device configured to fix the non-contact detection module 2.

The light-transmitting hole 6 is a hole disposed in the end cap 5 of the measurement device. A size of the light-transmitting hole 6 may be adapted to the measuring end of the laser emitter. The light-transmitting hole 6 may be configured to allow a laser beam emitted by the laser emitter to pass through without obstruction.

The end cap 5 may be threadedly connected to a bottom of the housing. A center position of the end cap 5 may be provided with the light-transmitting hole 6.

In some embodiments, the end cap 5 may be threadedly connected to the bottom of the housing. The light-transmitting hole 6 disposed at the center position of the end cap 5 provides a protected and precise optical path exit for the laser emitter inside the housing. The light-transmitting hole 6 ensures that the laser beam can be stably emitted to accurately calibrate the reference detection surface to trigger a measurement signal.

In some embodiments of the present disclosure, through the arrangement of the end cap 5 and the light-transmitting hole 6, the structure provides physical protection for the laser emitter and ensures that the laser beam accurately points to the reference detection surface. The structure can achieve both measurement accuracy and device durability.

In some embodiments, the communication module 3 includes a signal receiver. An input terminal of the signal receiver may be wirelessly and communicatively connected to the laser emitter, and an output terminal of the signal receiver may be communicatively connected to the signal acquisition port of the external machine tool.

In some embodiments, the communication module 3 establishes a wireless communication link between the laser emitter and the external machine tool through the signal receiver of the communication module 3. A trigger signal generated when the laser beam calibrates the reference detection surface is transmitted to the external machine tool to achieve automatic detection.

In some embodiments of the present disclosure, by setting the signal receiver, measurement data can be automatically and instantly transmitted to the machine tool, thereby achieving automation of the detection process.

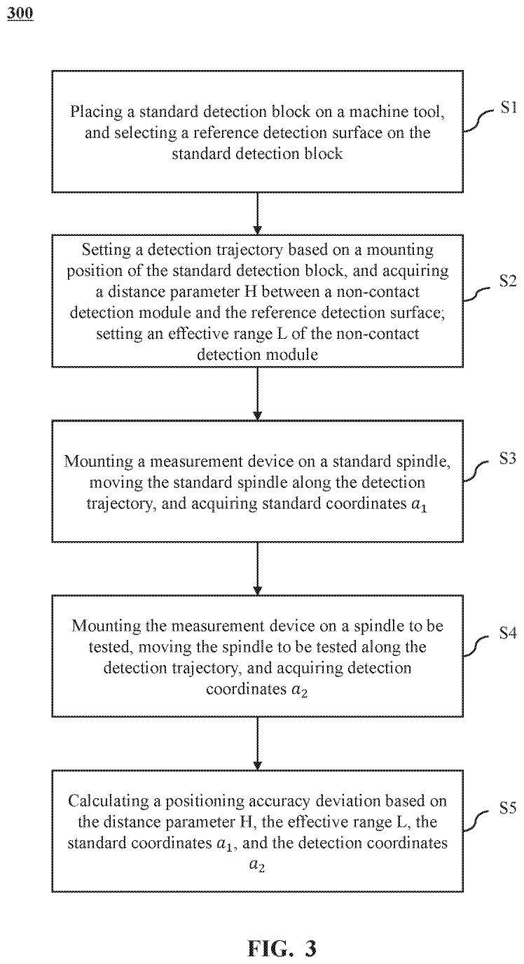

FIG. 3 is a flowchart of a measurement method for zero-point positioning of a machine tool rotary axis according to some embodiments of the present disclosure. A measurement method 300 includes operations S1-S5. The measurement method 300 may be performed based on the measurement device.

S1, placing a standard detection block on a machine tool, and selecting a reference detection surface on the standard detection block.

The standard detection block is a physical block with known dimensions and accuracy for providing the reference detection surface. More descriptions regarding the reference detection surface may be found in the related descriptions above.

In some embodiments, before performing zero-point positioning detection of the machine tool rotary axis, the standard detection block needs to be mounted at a mounting position on the machine tool. The mounting position is a point position on a worktable of the machine tool that is preselected for mounting the standard detection block.

In some embodiments, one surface of the standard detection block may be selected as the reference detection surface according to a rotary axis to be measured. For example, in response to a determination that a zero-point positioning accuracy of an A-axis of the machine tool needs to be determined, a top surface of the standard detection block may be selected as the reference detection surface. As another example, in response to a determination that a zero-point positioning accuracy of a C-axis of the machine tool needs to be determined, a side surface perpendicular to a measuring end of a laser emitter may be selected as the reference detection surface.

S2, setting a detection trajectory based on a mounting position of the standard detection block, and acquiring a distance parameter H between a non-contact detection module and the reference detection surface; setting an effective range L of the non-contact detection module.

The detection trajectory refers to a path along which the measurement device moves during a detection process.

In some embodiments, the detection trajectory may be a straight line. The detection trajectory passes through the reference detection surface and is parallel to the reference detection surface. The detection trajectory passing through the reference detection surface means that when a spindle of the machine tool drives the measurement device to move along the detection trajectory, at a specific position point on the detection trajectory, an end point of a laser beam emitted from the measurement device passes through or falls on the reference detection surface. A length of the laser beam is an effective range L. For example, when a zero-point positioning accuracy of an A-axis of the machine tool is measured, the detection trajectory may be a horizontal line that passes through the reference detection surface and is parallel to a Y-axis of the machine tool. When a zero-point positioning accuracy of a C-axis of the machine tool is measured, the detection trajectory may be a horizontal line that passes through the reference detection surface and is parallel to an X-axis of the machine tool.

In some embodiments, the detection trajectory may be pre-specified based on experience.

The distance parameter H refers to a distance between the detection trajectory and the reference detection surface.

Since the detection trajectory is parallel to the reference detection surface, a distance from any point on the detection trajectory to the reference detection surface is a constant value, i.e., the distance parameter H is a constant value.

In some embodiments, the data processing module 4 of the measurement device may read or adjust the distance parameter H through a control module of the laser emitter. More descriptions regarding the data processing module 4 and the control module may be found in the related descriptions above.

The effective range L of the non-contact detection module refers to a maximum detection distance at which the non-contact detection module can perform effective detection. For example, when the laser emitter is used as the non-contact detection module, the effective range L refers to a maximum detection length of a laser beam emitted by the laser emitter. In some embodiments, the data processing module of the measurement device may acquire or adjust parameters such as the effective range through the control module of the laser emitter.

It should be noted that to ensure that the laser beam can irradiate the reference detection surface, the distance parameter H is less than or equal to the effective range L.

S3, mounting a measurement device on a standard spindle, moving the standard spindle along the detection trajectory, and acquiring standard coordinates a₁.

The standard spindle refers to a spindle that has been adjusted and calibrated. During the measurement process, a zero-point positioning accuracy of the standard spindle meets requirements.

The standard coordinates refer to a spatial position coordinate value (denoted as a₁) of the measurement device (or a measurement point of the non-contact detection module) on the detection trajectory when a signal emitted by the non-contact detection module (e.g., the laser emitter) first calibrates the reference detection surface while the measurement device moves the standard spindle along the detection trajectory. More descriptions regarding the standard coordinates may be found in the related descriptions below.

S4, mounting the measurement device on a spindle to be tested, moving the spindle to be tested along the detection trajectory, and acquiring detection coordinates a₂.

The spindle to be tested refers to a spindle of the machine tool for which a zero-point positioning accuracy needs to be measured.

The detection coordinates refer to a coordinate value acquired when the non-contact detection module calibrates the reference detection surface during measurement using the spindle to be tested.

In some embodiments, operations for acquiring the detection coordinates (denoted as a₂) are consistent with operations for acquiring the standard coordinates. The measurement device may be removed from the standard spindle and mounted on the spindle to be tested, and the above operations of movement and measurement may be repeated. Specifically, the spindle to be tested may be controlled to move along the same detection trajectory, and when the non-contact detection module triggers a signal, coordinates of the machine tool may be recorded, and the coordinates may be the detection coordinates a₂.

To ensure consistency of measurement, the mounting position of the standard detection block, the detection trajectory, the distance parameter H, and the effective range L remain constant throughout the entire process. More descriptions regarding the detection coordinates may be found in the related descriptions below.

S5, calculating a positioning accuracy deviation based on the distance parameter H, the effective range L, the standard coordinates a₁, and the detection coordinates a₂.

The positioning accuracy deviation refers to a difference between an actual positioning position and a standard (or theoretical) positioning position of a machine tool rotary axis to be tested (e.g., an A-axis or a C-axis). The positioning accuracy deviation may be acquired by comparing the standard coordinates and the detection coordinates.

In some embodiments, the system may determine the positioning accuracy deviation by querying a deviation table according to the distance parameter H, the effective range L, the standard coordinates a₁, and the detection coordinates a₂. The deviation table may include a correspondence relationship among the distance parameter H, the effective range L, the standard coordinates a₁, the detection coordinates a₂, and the positioning accuracy deviation. The system may record distance parameters H, effective ranges L, standard coordinates a₁, detection coordinates a₂, and actual positioning accuracy deviations through manual determination from historical data into a table to form the deviation table. More descriptions regarding the positioning accuracy deviation may be found in the related descriptions below.

In some embodiments of the present disclosure, the measurement process is simplified by presetting the detection trajectory. Meanwhile, the distance parameter H is fixed. The distance parameter H no longer needs to be detected on site during the detection process. The count of parameters to be detected is reduced, which improves detection efficiency. In addition, by controlling the length (i.e., the effective range L) of the laser beam, corresponding measurement parameters are acquired at the first moment when the laser beam falls onto the reference detection surface. Interference from external equipment such as the worktable of the machine tool on the measurement process is excluded, thereby improving the measurement accuracy.

In some embodiments of the present disclosure, the non-contact detection module is adopted to avoid direct contact with the standard detection block. By controlling the effective range L of the non-contact detection module, a control signal is triggered only when a distance between the detection module and the reference detection surface is less than or equal to the effective range L. Therefore, precise and automatic data acquisition is achieved.

In some embodiments of the present disclosure, the distance parameter H is fixed through the detection trajectory, such that parameters in a calculation model are fixed. The amount of data to be collected is reduced, thereby improving the detection efficiency.

In some embodiments of the present disclosure, the measurement process no longer relies on a way of the mandrel touching the standard detection block. Instead, all parameters are collected at the first moment when the reference detection surface is calibrated. Corresponding results are automatically calculated and output, which helps a person skilled in the art quickly determine whether zero-point positioning of the machine tool rotary axis meets the requirements, thereby maximizing the detection efficiency.

In some embodiments of the present disclosure, the device has a fast detection speed. The detection process does not require manual intervention. The detection results are not affected by skill levels of operators. The measurement device is particularly suitable for a mass production mode based on a production line. The measurement device can effectively reduce the impact of machine tool accuracy detection on a product processing cycle. Since non-contact measurement is achieved, equipment damage caused by interference collisions with the machine tool or the standard block can be effectively avoided.

In some embodiments, a way for acquiring the standard coordinates includes: mounting the measurement device on the standard spindle; controlling the standard spindle to move to a starting point of the detection trajectory, and adjusting an attitude of the standard spindle to a first detection position or a second detection position; controlling the standard spindle to move along the detection trajectory until the non-contact detection module calibrates the reference detection surface; and acquiring coordinates when the non-contact detection module calibrates the reference detection surface, and using the coordinate as the standard coordinates.

S31, mounting the measurement device on the standard spindle.

In some embodiments, the measurement device may be mounted on the standard spindle by connecting a tool holder to a standard tool claw of the spindle of the machine tool. For example, an operator (or an automatic tool changing system of the machine tool) may insert and fix a tool holder of the measurement device into a tool claw (a tool handle clamping mechanism) of the standard spindle to complete mounting.

In some embodiments, a connection end of the mounting frame may be provided with a strong magnet. During mounting, the measurement device is fixed by magnetic adsorption by bringing a magnetic connection end of the measurement device to be close to an end face of the standard spindle. This mounting way is fast and suitable for scenarios requiring frequent disassembly and assembly.

In some embodiments, the measurement device may be mounted on the standard spindle by other mechanical ways such as threaded connection or flange connection, as long as mounting stability and repeat positioning accuracy are ensured.

S32, controlling the standard spindle to move to a starting point of the detection trajectory, and adjusting an attitude of the standard spindle to a first detection position or a second detection position.

The starting point of the detection trajectory refers to a starting position point of the detection trajectory.

The attitude of the standard spindle refers to a direction and angular state of the standard spindle in space. For example, the attitude may be defined by rotation angles of an A-axis and a C-axis.

The first detection position, i.e., an A-axis standard detection position, refers to a standard attitude position to which the spindle (including the A-axis and the C-axis) of the machine tool needs to be adjusted when measuring a zero-point positioning accuracy of the A-axis of the machine tool. For example, the first detection position may be a position where the A-axis is at 0° and the C-axis is at 0°.

The second detection position, i.e., a C-axis standard detection position, refers to a standard attitude position to which the spindle of the machine tool needs to be adjusted when measuring a zero-point positioning accuracy of the C-axis of the machine tool. For example, the second detection position may be a position where the A-axis is at 900 and the C-axis is at 0°. More descriptions regarding the first detection position and the second detection position may be found in the related descriptions below.

In some embodiments, controlling the standard spindle to move to a starting point of the detection trajectory may be implemented by executing a preset numerical control program. For example, the operator inputs coordinates of the starting point into a numerical control system of the machine tool, and a servo system of the machine tool drives each linear axis to precisely move the spindle to the position. For example, by executing an instruction “A0, C0” in the numerical control system, the A-axis is controlled to rotate to a 0° position, and the C-axis is controlled to rotate to a 0° position. As another example, by executing an instruction “A90, C0” in the numerical control system, the A-axis is controlled to rotate to a 900 position, and the C-axis is controlled to rotate to a 0° position.

In some embodiments, a way of controlling spindle movement and adjusting the attitude may include manually operating a control panel of the machine tool or sending an instruction to a controller of the machine tool via an external computer, or the like.

S33, controlling the standard spindle to move along the detection trajectory until the non-contact detection module calibrates the reference detection surface.

In some embodiments, the standard spindle is controlled to move along a preset detection trajectory. For example, when the zero-point positioning accuracy of the A-axis of the machine tool is measured, the spindle is controlled to move in a direction toward Y− (i.e., a negative direction of a Y-axis); as another example, when the zero-point positioning accuracy of the C-axis of the machine tool is measured, the spindle is controlled to move in a direction toward X− (i.e., a negative direction of an X-axis).

When the laser emitter is not directly above the reference detection surface, since the length of the laser beam is limited, the end point of the laser beam cannot reach a surface of any physical structure, and thus no detection signal is fed back.

When the laser emitter moves to a position directly above the reference detection surface, since the distance parameter H is less than or equal to the effective range L, the laser beam is intercepted by the reference detection surface, the end point of the laser beam is located on the reference detection surface, the length of the laser beam is shortened, and a corresponding control signal is triggered and fed back.

S34, acquiring coordinates when the non-contact detection module calibrates the reference detection surface, and using the coordinate as the standard coordinates a₁.

In some embodiments, the control signal fed back by the laser emitter may be fed back to the data processing module via the communication module, the machine tool may stop, and a coordinate detection module of the machine tool may determine coordinates of an emission point of the laser emitter on the detection trajectory at this moment, and uses the coordinates as the standard coordinates a₁. For example, when the zero-point positioning accuracy of the A-axis of the machine tool is measured, the standard coordinates a₁ are Y₁-axis coordinates. As another example, when the zero-point positioning accuracy of the C-axis of the machine tool is measured, the standard coordinates a₁ are X₁-axis coordinates.

In some embodiments, a process of acquiring the coordinates is as follows: a trigger signal generated by the non-contact detection module is sent to a high-speed input port of a programmable logic controller (PLC) of the machine tool. After receiving the signal, the PLC immediately reads and latches precise machine tool coordinates of the spindle at that moment from a position encoder such as a servo driver or a grating scale.

In some embodiments, coordinates may be acquired by using a probing function of the numerical control system. A signal of the non-contact detection module is connected to a probe input interface of the system, and a probing instruction (e.g., G31) is used in a program for controlling spindle movement. When the system detects the trigger signal, the system automatically stops the spindle movement and records a coordinate value at the moment of triggering into a system variable.

In some embodiments of the present disclosure, by mounting the measurement device on a calibrated standard spindle, controlling the standard spindle to move along the preset trajectory in a specific attitude, and utilizing the non-contact detection module to trigger high-speed capture of coordinates, accurate and repeatable standard coordinates are acquired. The method provides a reliable benchmark for subsequent deviation calculation, and eliminates uncertainty of manual detection, thereby significantly improving the accuracy and reliability of the entire zero-point positioning accuracy measurement.

In some embodiments, the first detection position corresponds to a position where the A-axis is at 0° and the C-axis remains at 0°; the second detection position corresponds to a position where the A-axis is at 90° and the C-axis is at 0°.

In some embodiments, if the zero-point positioning accuracy of the A-axis of the machine tool is measured, an attitude of the standard spindle is adjusted to an A-axis standard detection position, the A-axis standard detection position indicating that the A-axis is at 0° and the C-axis remains at 0°; if the zero-point positioning accuracy of the C-axis of the machine tool is measured, the attitude of the standard spindle is adjusted to a C-axis standard detection position, the C-axis standard detection position indicating that the A-axis is at 900 and the C-axis remains at 0°.

In some embodiments of the present disclosure, a corresponding posture parameter is selected according to an axis to be determined and each axis of the machine tool is controlled according to the parameter.

Then the spindle of the machine tool is controlled to move to the starting point of the detection trajectory set in the operation S2. In a specific embodiment, it is ensured that the emission point of the laser emitter is located at the starting point of the detection trajectory through an external detection device or coordinate point position control, or the like.

In some embodiments, mounting the measurement device on the spindle to be tested, moving the spindle to be tested along the detection trajectory, and acquiring detection coordinates includes: mounting the measurement device on the spindle to be tested; moving the spindle to be tested to the starting point of the detection trajectory; controlling the spindle to be tested to move along the detection trajectory until the non-contact detection module calibrates the reference detection surface; and acquiring coordinates when the non-contact detection module calibrates the reference detection surface, and using the coordinates as the detection coordinates.

S41, mounting the measurement device on the spindle to be tested.

It should be noted that, after the measurement device is mounted, coordinates of the laser emission point of the laser emitter are the same as the coordinates in the operation S31, to improve the detection accuracy.

S42, moving the spindle to be tested to a starting point of the detection trajectory. That is, the laser emission point of the laser emitter coincides with the starting point.

It should be noted that the above detection trajectory is the same trajectory as the detection trajectory in the operation S2.

S43, controlling the spindle to be tested to move along the detection trajectory until the non-contact detection module calibrates the reference detection surface.

In some embodiments, when the zero-point positioning accuracy of the A-axis of the machine tool is measured, the spindle is controlled to move in a direction toward Y− (i.e., the negative direction of the Y-axis); when the zero-point positioning accuracy of the C-axis of the machine tool is measured, the spindle is controlled to move in a direction toward X− (i.e., the negative direction of the X-axis).

S44, acquiring coordinates when the non-contact detection module calibrates the reference detection surface, and using the coordinates as the detection coordinates a₂.

In some embodiments, when the laser emitter moves directly above the reference detection surface, since the distance parameter H is less than or equal to the effective range L, the laser beam is intercepted by the reference detection surface. The end point of the laser beam is located on the reference detection surface, and the length of the laser beam is shortened, thereby triggering and feeding back a corresponding control signal.

In some embodiments, the control signal fed back by the laser emitter may be fed back to the data processing module through the communication module, and the machine tool may stop. Meanwhile, coordinates of the emission point of the laser emitter on the detection trajectory at this time may be determined by the coordinate detection module of the machine tool, and the coordinates may be used as the detection coordinates a₂.

In some embodiments, when the zero-point positioning accuracy of the A-axis of the machine tool is measured, the detection coordinates a₂ are Y₂-axis coordinates. When the zero-point positioning accuracy of the C-axis of the machine tool is measured, the detection coordinates a₂ are X₂-axis coordinates.

In some embodiments of the present disclosure, the non-contact detection module is adopted for calibration, which avoids measurement errors and risks of equipment damage caused by physical contact. When the non-contact detection module calibrates the reference surface, the system automatically and instantaneously captures the coordinates, eliminating delay and subjectivity of manual reading or determination, thereby greatly improving accuracy and repeatability of coordinate acquisition. The entire process requires no manual intervention, has a fast detection speed, and significantly improves the detection efficiency for zero-point positioning of the machine tool, particularly suitable for automated production lines.

In some embodiments, calculating a positioning accuracy deviation based on the distance parameter, the effective range, the standard coordinates, and the detection coordinates includes: determining a deviation direction based on the spindle to be tested; selecting a deviation calculation formula based on the deviation direction; and calculating the positioning accuracy deviation based on the standard coordinates, the detection coordinates and the deviation calculation formula.

S51, determining a deviation direction based on the spindle to be tested.

The deviation direction refers to a direction of an angular offset of a zero-point position of a rotary axis (the A-axis or the C-axis) of the spindle to be tested relative to a zero-point position of the standard spindle. The deviation direction reflects an orientation of a zero-point error in a circumferential direction. In some embodiments, the deviation direction may be a positive deviation or a negative deviation.

The positive deviation reflects that a zero-point of a rotary axis (the A-axis or the C-axis) of the spindle to be tested has undergone an angular offset in a specific direction relative to a standard zero-point. If the deviation direction is the positive deviation, the angular offset causes a result: when moving along the same detection trajectory to calibrate the same reference detection surface, the spindle of the machine tool needs to move a longer linear distance than in a standard case to trigger a signal, i.e., a trigger point is “delayed”.

The negative deviation reflects that a zero-point of the rotary axis of the spindle to be tested has undergone an angular offset opposite to the positive deviation relative to the standard zero-point. If the deviation direction is the negative deviation, the angular offset causes a result: when moving along the same detection trajectory to calibrate the same reference detection surface, the spindle of the machine tool only needs to move a shorter linear distance than the standard case to trigger a signal, i.e., a trigger point is “advanced”.

In some embodiments, the deviation direction may be determined by comparing the standard coordinates and the detection coordinates with a deviation preset table. The deviation preset table may include a correspondence relationship among the standard coordinates, the detection coordinates, and the deviation direction. The deviation preset table may be preset based on manual experience. More descriptions regarding the deviation direction may be found in the related descriptions below.

S52, selecting a deviation calculation formula based on the deviation direction.

The deviation calculation formula refers to a mathematical expression used to calculate a deviation value. For example, the deviation calculation formula may include a positive deviation formula and a negative deviation formula. More descriptions regarding the positive deviation formula and the negative deviation formula may be found in the related descriptions below.

In some embodiments, at least two deviation calculation formulas are preset in the data processing module and correspond to the positive deviation and the negative deviation, respectively. When the deviation direction determined in a previous operation is the positive deviation, the system selects the positive deviation formula for subsequent calculation. When the deviation direction determined in a previous operation is the negative deviation, the system selects the negative deviation formula for calculation.

S53, calculating the positioning accuracy deviation based on the standard coordinates, the detection coordinates and the deviation calculation formula.

In some embodiments, the standard coordinates and the detection coordinates may be substituted into the selected deviation calculation formula to calculate the positioning accuracy deviation. More descriptions regarding the standard coordinates and the detection coordinates may be found in the related descriptions above.

In some embodiments of the present disclosure, by first determining the deviation direction and then selecting a corresponding formula, a calculation model is ensured to precisely match an actual geometric state of spindle deflection, thereby significantly improving calculation accuracy and reliability of the zero-point positioning accuracy deviation.

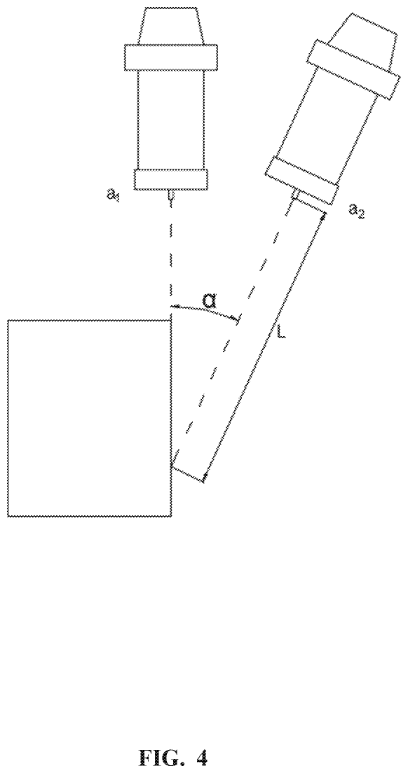

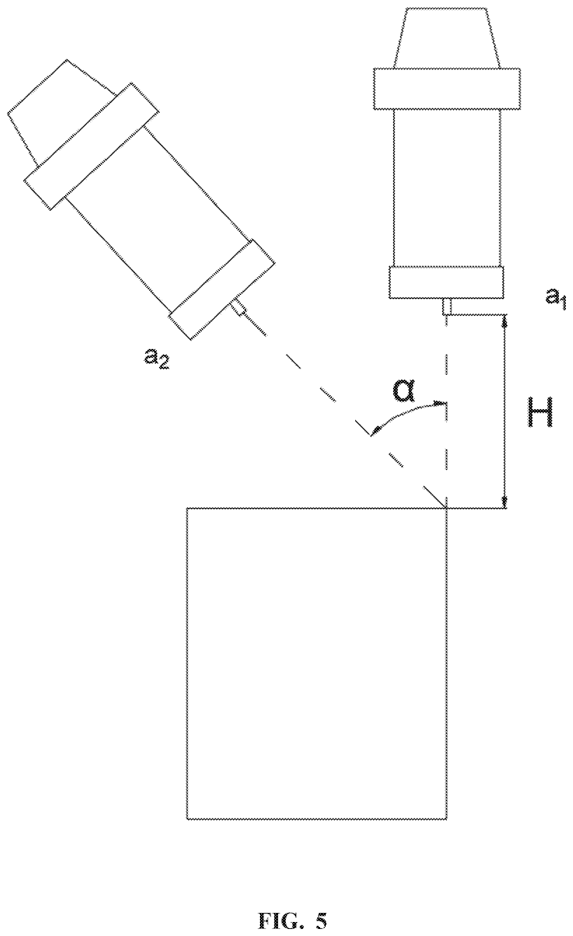

FIG. 4 is a schematic diagram of a calculation principle of a positive deviation according to some embodiments of the present disclosure. FIG. 5 is a schematic diagram of a calculation principle of a negative deviation according to some embodiments of the present disclosure.

In some embodiments, determining a deviation direction of the spindle to be tested includes: calculating a coordinate difference between the standard coordinates and the detection coordinates; in response to the coordinate difference being positive, determining that the deviation direction of the spindle to be tested is a positive deviation; and in response to the coordinate difference being negative, determining that the deviation direction of the spindle to be tested is a negative deviation.

S511, calculating a coordinate difference between the standard coordinates and the detection coordinates.

In some embodiments, the coordinate difference between the standard coordinates and the detection coordinates may be calculated according to a formula Δa=a₁−a₂.

Referring to FIGS. 4-5, FIG. 4 shows a state when the positive deviation occurs, FIG. 5 shows a state when the negative deviation occurs, and a is an angular deviation value caused by a zero-point deviation of the spindle, i.e., a positioning accuracy deviation to be calculated. The deviation direction cannot be directly observed with naked eyes, and the detection trajectory is predetermined before measurement starts. Accordingly, when the zero-point positioning accuracy of the A-axis of the machine tool is measured, only a Y coordinate changes; when the zero-point positioning accuracy of the C-axis of the machine tool is measured, only an X coordinate changes. Based on this, the deviation direction can be quickly and reliably determined as the positive deviation or the negative deviation by calculating the coordinate difference between the standard coordinates and the detection coordinates.

S512, in response to the coordinate difference being positive, determining that the deviation direction of the spindle to be tested is a positive deviation.

If Δa=a₁−a₂>0, the deviation direction of the spindle to be tested is the positive deviation.

S513, in response to the coordinate difference being negative, determining that the deviation direction of the spindle to be tested is a negative deviation.

If Δa=a₁−a₂<0, the deviation direction of the spindle to be tested is the negative deviation.

If Δa=a₁−a₂=0, the spindle to be tested has no deviation.

In some embodiments of the present disclosure, rapid and automatic determination of the deviation direction of the spindle is achieved by calculating the coordinate difference and determining whether the coordinate difference is positive or negative.

In some embodiments, the deviation calculation formula may include a positive deviation formula and a negative deviation formula. The positive deviation formula is expressed by:

$${θ}_{1} = arcsin \frac{\vert {a}_{1} - {a}_{2} \vert}{L} ;$$

the negative deviation formula is expressed by:

$${θ}_{2} = arctan \frac{\vert {a}_{1} - {a}_{2} \vert}{H} ;$$

where L denotes the effective range, H denotes the distance parameter, a₁ denotes the standard coordinates, and a₂ denotes the detection coordinates.

In response to a determination that the deviation direction is the positive deviation, the positive deviation formula

$${θ}_{1} = arcsin \frac{\vert {a}_{1} - {a}_{2} \vert}{L}$$

is invoked, and parameters acquired in the operations S34-S44 are substituted into the above parameters for calculation.

In response to a determination that the deviation direction is the negative deviation, the negative deviation formula

$${θ}_{2} = arctan \frac{\vert {a}_{1} - {a}_{2} \vert}{H}$$

is invoked, and parameters acquired in the operations S34-S44 are substituted into the above parameters for calculation.

The deviation calculation formula provided in some embodiments of the present disclosure establishes an accurate mathematical model for positioning deviation. The deviation calculation formula can directly and accurately convert a linear coordinate deviation (a₁−a₂) into the positioning accuracy deviation for zero-point positioning of the machine tool rotary axis. The deviation calculation formula ensures accuracy and reliability of detection results and effectively improves the calibration efficiency and accuracy of zero-point positioning of the machine tool.

The above embodiments are merely preferred embodiments of the present disclosure and are not intended to limit the patent protection scope of the present disclosure. Any equivalent structure or equivalent process transformation made based on the content of the specification and drawings of the present disclosure, or any direct or indirect application in other related technical fields, shall similarly fall within the patent protection scope of the present disclosure.

What is claimed is:

1. A measurement device for zero-point positioning of a machine tool rotary axis, comprising:
a mounting frame;
a non-contact detection module, wherein the non-contact detection module is configured to calibrate a reference detection surface, and the non-contact detection module is connected to the mounting frame;
a communication module, wherein the communication module is communicatively connected to the non-contact detection module; and
a data processing module, wherein the data processing module is communicatively connected to the communication module.

2. The measurement device according to claim 1, wherein the non-contact detection module includes a laser emitter; a bottom of the mounting frame is provided with an end cap, and the end cap is provided with a light-transmitting hole adapted to a measuring end of the laser emitter.

3. The measurement device according to claim 2, wherein the communication module includes a signal receiver, an input terminal of the signal receiver is wirelessly and communicatively connected to the laser emitter, and an output terminal of the signal receiver is communicatively connected to a signal acquisition port of an external machine tool.

4. A measurement method for zero-point positioning of a machine tool rotary axis, comprising:
placing a standard detection block on a machine tool, and selecting a reference detection surface on the standard detection block;
setting a detection trajectory based on a mounting position of the standard detection block, and acquiring a distance parameter between a non-contact detection module and the reference detection surface; and setting an effective range of the non-contact detection module;
mounting a measurement device on a standard spindle, moving the standard spindle along the detection trajectory, and acquiring standard coordinates;
mounting the measurement device on a spindle to be tested, moving the spindle to be tested along the detection trajectory, and acquiring detection coordinates; and
calculating a positioning accuracy deviation based on the distance parameter, the effective range, the standard coordinates, and the detection coordinates.

5. The measurement method according to claim 4, wherein the mounting a measurement device on a standard spindle, moving the standard spindle along the detection trajectory, and acquiring standard coordinates includes:
mounting the measurement device on the standard spindle;
controlling the standard spindle to move to a starting point of the detection trajectory, and adjusting an attitude of the standard spindle to a first detection position or a second detection position;
controlling the standard spindle to move along the detection trajectory until the non-contact detection module calibrates the reference detection surface; and
acquiring coordinates when the non-contact detection module calibrates the reference detection surface, and using the coordinate as the standard coordinates.

6. The measurement method according to claim 5, wherein the first detection position corresponds to a position where an A-axis is at 0° and a C-axis remains at 0°; and the second detection position corresponds to a position where the A-axis is at 90° and the C-axis is at 0°.

7. The measurement method according to claim 4, wherein the mounting the measurement device on a spindle to be tested, moving the spindle to be tested along the detection trajectory, and acquiring detection coordinates includes:
mounting the measurement device on the spindle to be tested;
moving the spindle to be tested to a starting point of the detection trajectory;
controlling the spindle to be tested to move along the detection trajectory until the non-contact detection module calibrates the reference detection surface; and
acquiring coordinates when the non-contact detection module calibrates the reference detection surface, and using the coordinates as the detection coordinates.

8. The measurement method according to claim 4, wherein the calculating a positioning accuracy deviation based on the distance parameter, the effective range, the standard coordinates, and the detection coordinates includes:
determining a deviation direction based on the spindle to be tested;
selecting a deviation calculation formula based on the deviation direction; and
calculating the positioning accuracy deviation based on the standard coordinates, the detection coordinates and the deviation calculation formula.

9. The measurement method according to claim 8, wherein the determining a deviation direction of the spindle to be tested includes:
calculating a coordinate difference between the standard coordinates and the detection coordinates;
in response to the coordinate difference being positive, determining that the deviation direction of the spindle to be tested is a positive deviation; and
in response to the coordinate difference being negative, determining that the deviation direction of the spindle to be tested is a negative deviation.

10. The measurement method according to claim 4, wherein a deviation calculation formula includes a positive deviation formula and a negative deviation formula, the positive deviation formula is expressed by:
$${θ}_{1} = arcsin \frac{\vert {a}_{1} - {a}_{2} \vert}{L} ;$$
and the negative deviation formula is expressed by:
$${θ}_{2} = arctan \frac{\vert {a}_{1} - {a}_{2} \vert}{H} ;$$
where L denotes the effective range, H denotes the distance parameter, a₁ denotes the standard coordinates, and a₂ denotes the detection coordinates.
